(19) United States
(12) Patent Application Publication
(10) Pub. No.: US 2009/0073464 A1
(43) Pub. Date: Mar. 19, 2009

(54) Selective Color Replacement

(76) Inventor: Barinder Singh Rai, Surrey (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/856,816

(22) Filed: Sep. 18, 2007

(51) Int. Cl. H04N 1/60

(52) U.S. Cl. 358/1.9

(57) ABSTRACT

One embodiment is directed to a method that includes inspecting a frame of image data transmitted as a stream of pixels. At least one of the pixels in the stream is selected and the color of selected pixels is changed. The steps of inspecting, selecting, and changing the color of selected pixels may be performed as the data is transmitted. The frame may be transmitted for storing in a memory and the steps may be performed as the frame is stored in the memory. Alternatively, the frame may be transmitted from a memory and the steps may be performed as the frame is fetched from in the memory. The selected pixels may be pixels within a particular region of the frame or the selected pixels may have a particular color component value.

### FIELD

The invention relates generally to manipulating digital images. More specifically, the invention relates to replacing the color of selected pixels of a digital image.

### BACKGROUND

While various techniques are known for manipulating digital images, the known techniques generally use significant amounts of memory and involve complicated processing. In addition, known techniques for manipulating digital images often are not available at the time an image is captured, a time when a user may wish to see the effect. Instead, a digital image or video must be transferred to a personal computer (“PC”) where it is manipulated. Not only does this require the use of an additional device, the software for modifying an image on a PC is expensive.

Accordingly, methods and apparatus for replacing the color of selected pixels of a digital image in a way that minimizes memory and processing requirements, and which permits the modification to be seen at the time the image is captured are desirable.

### SUMMARY

The problem replacing the color of selected pixels of a digital image in a way that minimizes memory and processing requirements and which permits the modification to be seen at the time the image is captured may be solved by a method, a display controller, or a system embodying the principles of the invention.

In one embodiment, a method includes inspecting a frame transmitted as a stream of pixels. At least one of the pixels in the stream is selected and the colors of selected pixels are changed. The steps of inspecting, selecting, and changing the colors of selected pixels may be performed as the frame is transmitted. The frame may be transmitted for storing in a memory and the steps may be performed as the frame is stored in the memory. In one alternative, the frame may be transmitted from a memory and the steps may be performed as the frame is fetched from the memory. The selected pixels may be pixels within a particular region of the frame. Alternatively, the selected pixels may have a particular color component value.

In one embodiment, a display controller includes a first unit to receive a frame of pixels from a source, to modify the color of particular received pixels, and to write received pixels to a destination. In one embodiment, the display controller may receive, modify, and write pixels at at least the rate at which pixels are required by the destination. Alternatively, the display controller may receive, modify, and write pixels at at least the rate at which pixels are received from the source. The particular received pixels that are modified may be pixels having a particular color component or they may be pixels located within a particular region of the frame.

In one embodiment, a system includes a first unit to receive a frame of pixels from an image data source, to extract the color of first received pixels, to select second received pixels, and to modify the color of the selected pixels. The color extraction, pixel selection, and color modification may be performed as the frame is received. The system may be a mobile device.

It is to be understood that this summary is provided as a means of generally determining what follows in the drawings and detailed description and is not intended to limit the scope of the invention.

### BRIEF DESCRIPTION OF THE DRAWINGS

FIG. 1 is a simplified representation of an exemplary frame.

FIG. 2 is a simplified block diagram of a system having a display controller.

FIG. 3 is a simplified block diagram of the display controller of FIG. 2 according to one embodiment of the present disclosure.

FIG. 4 is a simplified block diagram of the display controller of FIG. 2 according to another embodiment of the present disclosure.

FIG. 5 a flow diagram of an exemplary method according to the present disclosure.

FIG. 6 is a flow diagram of another exemplary method according to the present disclosure.

In the drawings and description below, the same reference numbers are used in the drawings and the description generally to refer to the same or like parts, elements, or steps.

### DETAILED DESCRIPTION

Before describing the principles of the invention and various embodiments, it may be helpful to briefly review the general nature of digital image data. An image on a display device is formed from small discrete elements known as “pixels.” The attributes of each pixel are represented by a numeric value, which is typically represented in binary form. Thus, an image may be considered an array of binary elements of data that may be referred to as a “frame.” A pixel may be represented by any number of bits. A common number for color pixels is 24 bits, though fewer bits are also often used. A color pixel may be of the RGB type, having three 8-bit values corresponding with red, blue, and green components. A color pixel may also be of the YUV type, having three 8-bit values corresponding with a luma, and two-color difference components. A single frame may be used to render a static image on a display device. A sequence of frames may be used to render video. While a frame often refers to the quantity of image data required to fill a display screen or captured by an image sensor, the term frame, as used in this description and in the claims, includes any array of pixels, regardless of size, such as a frame that is smaller than a frame that fills a particular display screen.

A frame is often transmitted from a source of image data as a stream of pixels arranged in raster order. Similarly, a frame is often transmitted to a display device as a stream of pixels arranged in raster order. In raster order, pixels are transmitted sequentially one line at a time, from top to bottom. The transmission of each line begins with the left-most pixel, proceeding sequentially to the right-most pixel. In order for a display screen of a display device to correctly render an image, a frame must be transmitted to the display device a prescribed number of times per second. Different types of display devices require different frame refresh rates. For example, an LCD display screen may require a new frame 60 times per second. In each frame refresh cycle, an entire frame is transmitted to the display device.

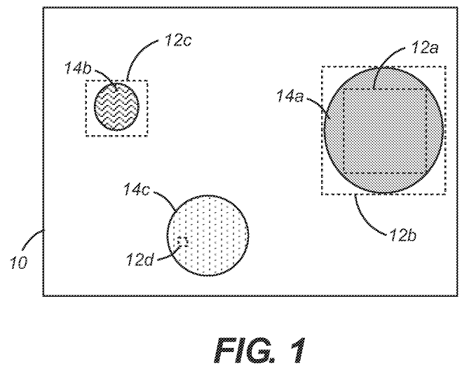

FIG. 1 depicts an exemplary frame 10 of pixels. The frame 10 is an image of three colored circles 14a, 14b, and 14c. The circles and the background may each be a different color. In FIG. 1, four exemplary regions 12a, 12b, 12c, and 12d are shown. The regions 12 are exemplary, and may be any shape or size, ranging from a single point to an entire frame. According to the principles of the invention, (a) a region of a frame may be selected for color replacement, (b) a range of color to replace may be selected, and (c) a replacement range of color may be selected. As an example of (a), any of the regions 12 may be selected for color replacement. As one example of (b), the range of color to replace may be selected by determining the range of color found within any of the regions 12. In addition, as an example of (c), the replacement range of color may be selected by determining the range of color found within any of the regions 12.

As another example of (b) a range of color to replace, assume that the portion of circle 14a within region 12a is generally medium blue. However, the color is not uniform and the range of color within the region 12a may be specified by the maximum and minimum color component values shown below:

| Medium Blue | Component | Minimum | Maximum |
|---|---|---|---|
| Red | 100 | 90 | 110 |
| Green | 149 | 139 | 159 |
| Blue | 237 | 227 | 247 |

In addition, as another example of (c) a replacement range of color consider the portion of object 14c within region 12d. Assume that this color is orange. A replacement range of color based on the orange color within region 12d may be specified by an orange color value and adjustment parameters for each color component as follows.

| Orange | Component | Adjustment |
|---|---|---|
| Red | 255 | 145 |
| Green | 99 | −50 |
| Blue | 71 | −166 |

To replace the color of a pixel with a color from the replacement range of color, the pixel's component values are changed according to the adjustment parameters. For example, if a pixel has component values of red=92, green=158, blue=237, the component values of the pixel will be changed to red=237, green=108, blue=71. In effect, the range of the replacement color corresponds to a range of color to replace. An adjustment parameter may be the difference between the component to replace and the replacement component, e.g. 99−149=−50. In addition, an adjustment parameter may be altered to account for the fact that the result of the subtraction must be within the range of 0-255 for an 8-bit component.

The selection of a region 12 may be performed in any of a variety of ways known in the art. For example, a region 12 may be selected using an input device to select a region of a frame rendered on the display device. The input device may be a stylus, a touch-screen feature for the display, or cross-hairs displayed on the screen and controlled by finger dials. A region 12 may be selected with a lasso-type device. Further, an edge-detection function may be used to select a region defined by an object. A region 12 may also be selected by inputting coordinate values. As mentioned, a range of color to replace may be selected by determining the range of color found within any of the regions 12, and a replacement range of color may also be selected by determining the range of color found within any of the regions 12. The manner in which a range of color to replace and a replacement range of color may be determined from a region 12 is described below.

In addition to selecting a range of color to replace or a replacement range of color by selecting a region 12, a color may be selected from a predetermined palette of colors. Moreover, a color may be directly input as numeric values.

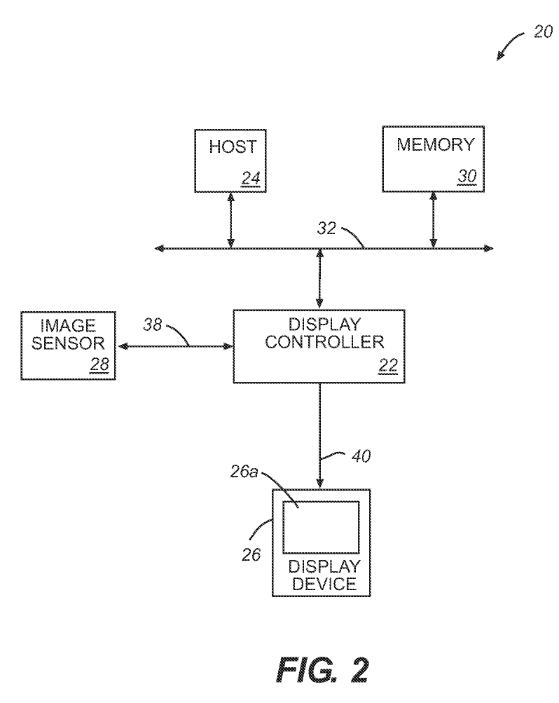

FIG. 2 is a simplified block diagram of a computer system 20 according to one embodiment of the present disclosure. The system 20 may be a mobile device (defined below). Where the system 20 is a mobile device, it is typically powered by a battery (not shown). The system 20 may include a display controller 22, a host 24, at least one display device 26 and one or more image data sources, such as image sensor 28. In addition, the system 20 may include a memory 30.

The display controller 22 interfaces the host 24 and image sensor 28 with the display device 26. In one embodiment, the display controller 22 may be a separate integrated circuit from the remaining elements of a system.

The host 24 is typically a microprocessor, but it may be a digital signal processor, a CPU, or any other type of device or machine that may be used to control operations in a digital circuit. Typically, the host 24 controls operations by executing instructions that are stored in or on a machine-readable medium. A host interface 34 may be included in the display controller 22. Other devices may be coupled with the bus 32. For instance, the memory 30 may be coupled with the bus 32. The memory 30 may, for example, store instructions or data for use by the host 24, or image data that may be rendered using the display controller 22. The memory 30 may be an SRAM, DRAM, Flash, hard disk, optical disk, floppy disk, or any other type of memory. The host 24 may be coupled with the display controller 22 by a bus 32. The host 24 or memory 30 may be image data sources.

The image sensor 28 may be, for example, a charge-coupled device (“CCD”), a complementary metal-oxide semiconductor (“CMOS”) sensor, or other device for capturing an image. A camera interface 36 (“CAM I/F”) may be included in the display controller 22. The image sensor 28 may be coupled with the display controller by a bus 38. The image sensor 28 transfers a frame of image data at a particular rate. The frame transfer rate of the image sensor depends on the type and model of image sensor and how it is configured. An exemplary image sensor may, for example, have a frame rate of 15 frames per second.

The display device 26 may include a display screen 26a. The display device 26 may be any device capable of rendering images. The term “display device” is defined below. A display device interface 38 may be included in the display controller 22. The display device 26 may be coupled with the display controller 22 by a bus 40.

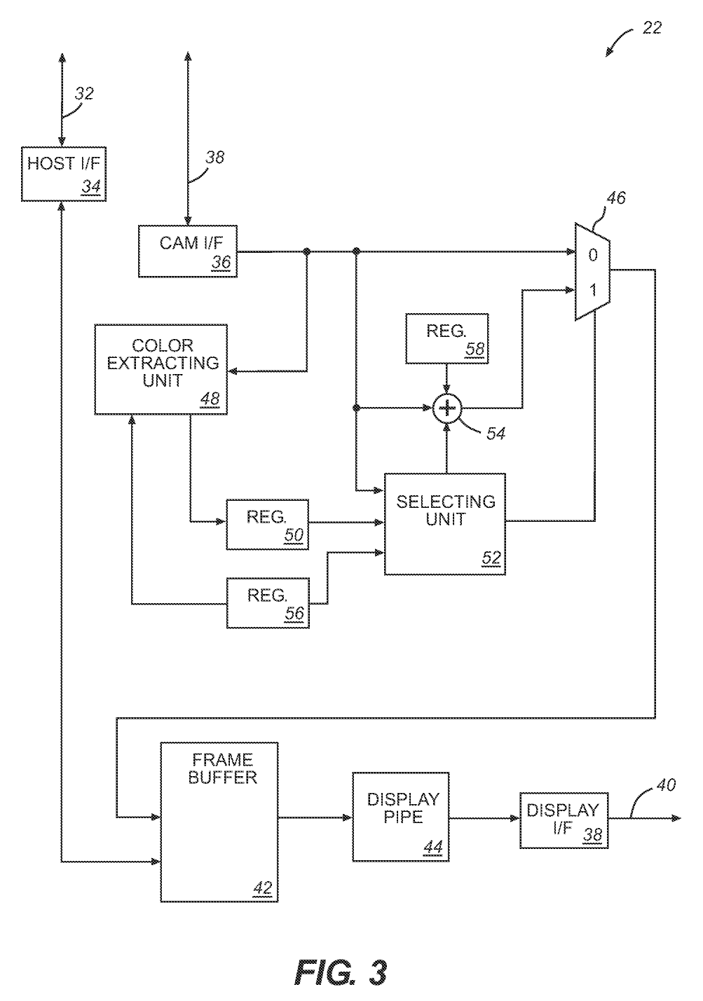

FIG. 3 is a simplified block diagram of the display controller 22 according to one embodiment. For clarity, various elements of the display controller 22 are omitted. The display controller 22 may include a memory 42. In other embodiments, however, the memory 42 may be remote from the display controller 22. The memory 42 may be used as a frame buffer for storing image data (and may be referred to as a frame buffer), but the memory 42 may also be used for storing other types of data. The memory 42 may be of the SRAM type. The memory 42 may also be a DRAM, Flash memory, hard disk, optical disk, floppy disk, or any other type of memory.

The capacity of the frame buffer 42 may vary in different embodiments. In one embodiment, the frame buffer 42 has a capacity which is sufficient to store no more than one frame of image data at a time, the frame size being defined by the display device 26 or the image sensor 28. In another embodiment, the frame buffer 42 has a capacity to store one frame of image data and some additional data, but the capacity is not sufficient to store two frames of image data. In an alternative embodiment, the frame buffer 42 may have a capacity which is sufficient to store more data than a single frame of image data.

A display pipe 44 may be included in the display controller 22. The display pipe 44 may be coupled with the frame buffer 42 and the display interface 38. Image data may be transferred from the frame buffer 42 to the display device 26 via the display pipe 44 and display interface 38. Image data may be stored in the frame buffer by the host 28 via the host interface 34, or by the image sensor 28 via the camera interface 36 and a selecting circuit 46.

In the shown embodiment, two operations may be performed on image data received from the image sensor 28. First, color information may be extracted from certain pixels by a color extraction unit 48. The extracted color information may be stored in register 50. Second, the color information of selected pixels may be changed. A selecting unit 52 selects pixels to be changed and directs a color component modifying unit 54 to change the color information of a selected pixel.

Color information may be extracted from pixels within a specified region of a frame by the color extraction unit 48. Location parameters for the specified region may be stored in a register 56. For example, the register 56 may store the (x, y) coordinates of a region 12. Referring to FIG. 1, for example, color information may be extracted from region 12a or 12d. In one embodiment, the color extraction unit 48 determines the maximum and the minimum values for pixel components within the specified region. The maximum and the minimum values for pixel components within a specified region may be stored in a register 50. As a frame is received from the image sensor 28 via the camera interface 36, the color extraction unit 48 monitors the transmission. Specifically, the unit 48 detects whether a pixel is located within the specified region using the location parameters stored in the register 56. If the unit 48 determines that a pixel is within the specified region, it compares the value of each color component of the pixel with component values stored in the register 50. For example, the red component value of an RGB pixel may be compared to the maximum and minimum red component values stored in the register 50. If the selected pixel's red value is either greater than the stored maximum red value or less than the stored minimum red value, the selected pixel's red value replaces the respective maximum or minimum value stored in the register 50. On the other hand, if the selected pixel's red value is neither greater than nor less than a stored maximum or minimum value, no value is stored in register 50. The maximum and minimum green and red component values may be determined in a similar manner.

The color extraction unit 48 determines the maximum and the minimum values for pixel components within a specified region as the frame is being stored in the frame buffer. In other words, the color extraction unit 48 is able to obtain color information for a particular region “on-the-fly” without delaying the transmission and without requiring additional memory to store a frame.

The color information of selected pixels of a frame may be changed by the selecting unit 52 and the color component modifying unit 54. The selecting unit 52 monitors the transmission of a frame and selects particular pixels for modification. If selecting unit 52 selects a pixel, the unit 52 directs the color component modifying unit 54 to change color information of the pixel. The selecting unit 52 may be coupled with a register 58 which stores adjustment parameters. For example, the register 58 may store red, green, and blue color component adjustment parameters, such as those shown in the table above. The modifying unit 54 may add the color component adjustment parameters to the corresponding color components of the selected pixel. Alternatively, the modifying unit 54 may perform a subtraction or other suitable operation.

The selecting unit 52 may check each pixel within a frame to determine if its color component values fall between the maximum and minimum color component values stored in the register 50. Alternatively, the unit 52 may check each pixel within a frame to determine if it is located within a specified region 12 using the location parameters stored in the register 56. With regard to determining if a pixel is located within a specified region 12, the selecting unit 52 may refer to the same region specified for use by the color extraction unit 48. Alternatively, the selecting unit 52 may determine if a pixel is located in one or more regions that are different from the region specified for use by the color extraction unit 48.

In one embodiment the selecting unit 52 may (a) check each pixel within a frame to determine if it is located within a specified region 12 and (b) check each pixel within the specified region to determine if its color component values fall between specified maximum and minimum color component values. For example, referring again to FIG. 1, the selecting unit 52 may check each pixel within a frame to determine if it is located within region 12b. If a pixel is found to be within the region 12b, the pixel is checked to determine if its color component values fall within a specified range of color to replace. The maximum and minimum color component values for the range of color to replace may be component values extracted from region 12a. If a pixel's color component values fall within the specified range of values, the color of the pixel is modified using a replacement range of color. The replacement range of color may be extracted from region 12d. Thus, in this example, the color of the object 12a may be changed to the color of object 14c.

The selecting unit 52 and the color component modifying unit 54 change color information of selected pixels of a frame as the frame is being stored in the frame buffer. In other words, the units 52 and 54 may change color information of selected pixels “on-the-fly” without delaying the transmission and without requiring additional memory to store a frame.

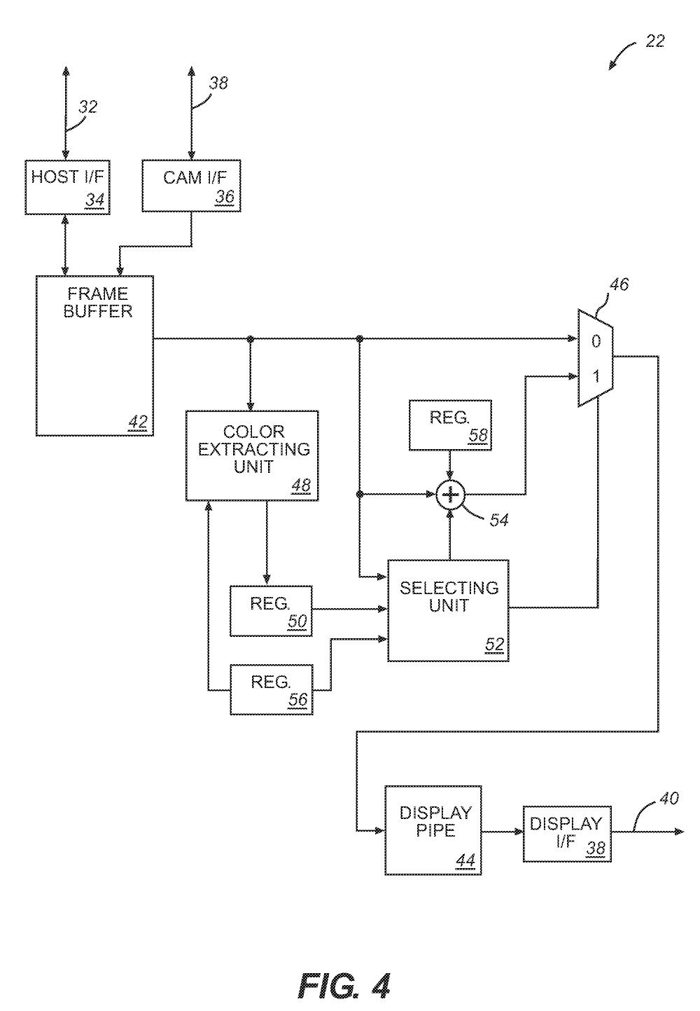

FIG. 4 is a simplified block diagram of the display controller 22 according to an alternative embodiment. The embodiment shown in FIG. 4 includes components that are the same as or similar to the components shown in FIG. 3. The embodiment shown in FIG. 4 may perform the same operations performed by the embodiment shown in FIG. 3, i.e., color information may be extracted from certain pixels and the color information of selected pixels may be changed. With respect to the embodiment shown in FIG. 3, image data is stored in the frame buffer 42 when it is received from the image sensor 28. In contrast, in FIG. 4, the functions of the color extracting unit 48, the selecting unit 52, and the modifying unit 54 are performed as pixels are fetched from the frame buffer 42. In addition, in the embodiment shown in FIG. 4, the display pipe 44 may be coupled with an output of the selecting unit 46,

In short, FIG. 3 illustrates an embodiment in which selective color extraction and selective color replacement may be performed as pixels are stored in a frame buffer, and FIG. 4 illustrates an embodiment in which selective color extraction and selective color replacement may be performed as pixels are fetched from the frame buffer. In an alternative embodiment, selective color extraction may be performed as pixels are stored in a frame buffer and selective color replacement may be performed as pixels are fetched from the frame buffer. In another alternative, selective color replacement may be performed as pixels are stored in a frame buffer and selective color extraction may be performed as pixels are fetched from the frame buffer. Moreover, in one embodiment, selective color extraction or selective color replacement may be performed as pixels are transmitted directly from an image data source, such as an image sensor, to a display device in a manner in which frames of pixels are not temporarily stored in a memory, such as the frame buffer 42, before being rendered on the display screen. For example, where the frame rate of the image sensor is equal to or greater than the frame refresh rate of the display device, a frame buffer may not be necessary.

As one example of the alternative embodiments described in the previous paragraph, consider a static image stored as a single frame in the frame buffer 42. In order to render the image on the display screen 26a, the frame is fetched from the memory 42 many times per second. If selective color replacement is performed as pixels are fetched from the frame buffer 42, a user may immediately see the effect of the color replacement. Upon viewing the color replacement, the user may decide that the particular color replacement is not desired. Because, in this example, the frame stored in the frame buffer 42 is not changed, the user may “undo” or reverse the effect simply by turning the selective color replacement feature off. Alternatively, the user may select a different replacement color and that color may be applied on the next fetch of the frame from the frame buffer. As another example of the alternative embodiments described in the previous paragraph, consider video where a sequence of frames are stored in and fetched from the frame buffer 42. Selective color extraction may be performed as pixels are stored in the frame buffer and selective color replacement may be performed as pixels are fetched from the frame buffer. If color is extracted from a selected region, the color may change as lighting conditions change. However, with each frame in the sequence, color information for the selected region is extracted so that the change in lighting conditions does not affect the color replacement process. As a third example, consider video where selective color replacement is performed as pixels are stored in the frame buffer. If the user wishes to reverse or change the effect, the selective color replacement feature may be turned off beginning with the next frame in the sequence of frames. As yet one more example, selective color extraction may be performed on a first frame in a sequence of video frames and selective color replacement may be performed on a subsequent frame in the sequence of frames.

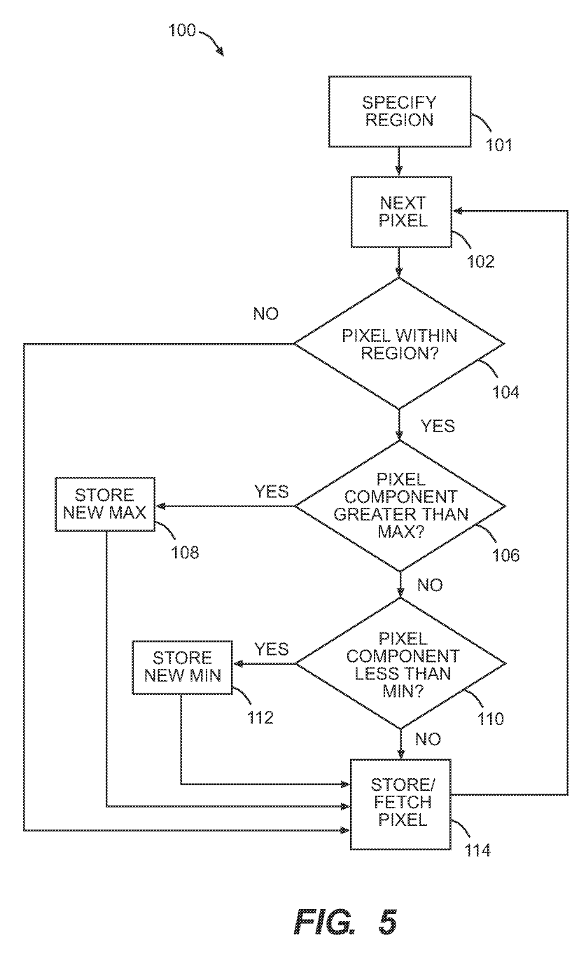

A method 100 for selective color extraction is shown in FIG. 5. A region of a frame is specified (step 101). A frame is processed a pixel at a time and a next pixel of the frame is identified (step 102). The coordinates of the pixel are inspected to determine if the pixel falls within the specified region (step 104). If the pixel is within the specified region, a color component of the pixel is checked to determine whether it is greater than the current maximum component value (step 106). If the component value is greater than the current maximum value, the maximum value for that component is updated (step 108). If the component value is less than the current maximum value, the pixel is checked to determine whether it is less than the current minimum component value (step 110). If the component value is less than the current minimum value, the minimum value for that component is updated (step 112). The pixel may be either stored or fetched in step 114, depending on whether selective color extraction is performed as the frame is stored in a frame buffer or as the frame is fetched from a frame buffer. While the method 100 is described with respect to a single color component, it will be appreciated that appropriate steps of the method may be replicated so that maximum and minimum color component values may be obtained for two or three color components.

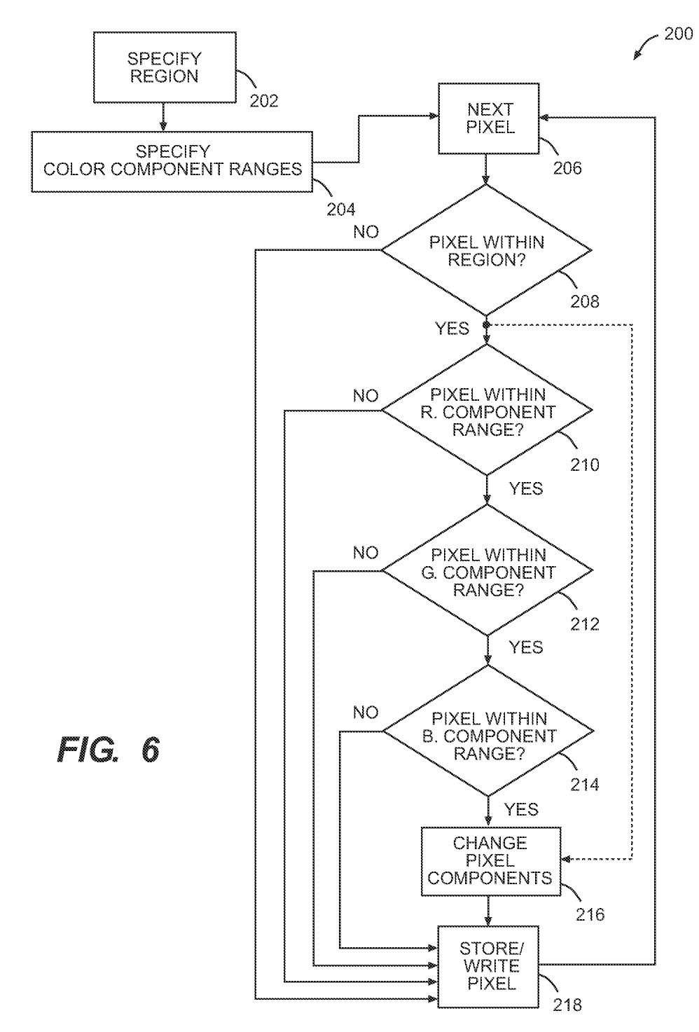

A method 200 for selective color replacement is shown in FIG. 6. One or more regions of a frame may be specified (step 202) or color component ranges may be specified (step 204). In one embodiment, one or more regions of a frame and color component ranges may be specified. A frame is processed a pixel at a time and in step 206 each next pixel of the frame is identified. The coordinates of the pixel may be inspected to determine if the pixel is within the specified region (step 208). In one embodiment, if the pixel is within the specified region, the method advances to step 210. If the pixel is within the specified region, the red color component of the pixel is checked to determine whether it is within the specified red component range (step 210). If the pixel is within the specified red color range, the method 200 advances to step 212. The green color component of the pixel is checked to determine whether it is within the specified green component range (step 212). If the pixel is within the specified green color range, the method 200 advances to step 214. The blue color component of the pixel is checked to determine whether it is within the specified blue component range (step 214). If the pixel is within the specified blue color range, the method 200 advances to step 216. In step 216, the pixel is modified. From step 216, the method proceeds to step 218 where the modified pixel is either stored or written to the display device depending on whether selective color replacement is performed as the frame is stored in a frame buffer or as the frame is fetched from a frame buffer. In addition, if the result of any of the tests in steps 208, 210, 212, or 214 is negative, the method proceeds to step 218 where the pixel is either stored or written to the display device without modification. In one alternative, the step 208 may be omitted. In another alternative, the steps 210, 212, and 214 may be omitted. In this embodiment, if it is determined in step 208 that a pixel is within the specified region, the method advances to step 216.

While embodiments have been described with respect to RGB pixel data, the principles of the invention may be practiced with pixel data of any type. In addition, embodiments have been described with frames of image data being received from an image sensor 28. In alternative embodiments, image data may be received in suitable source such as from the host 24 or from the memory 30. Moreover, while embodiments have been described with respect to raster ordered data, this is not critical. Data may be arranged in any desired order.

Method embodiments of the present disclosure may be implemented in hardware, or software, or in a combination of hardware and software. Where all or part of a method is implemented in software, a program of instructions may include one of more steps of a method and the program may be embodied on machine-readable media for execution by a machine. Machine-readable media may be magnetic, optical, or mechanical. A few examples of machine readable media include floppy disks, Flash memory, optical disks, bar codes, and punch cards. Some examples of a machine include disk drives, processors, USB drives, optical drives, and card readers. The foregoing examples are not intended be exhaustive lists of media and machines. In one embodiment, a method according to the present disclosure may be practiced in a computer system, such as the computer system 20.

Mobile or cellular telephones may include a digital camera. Often the camera may be used to capture either digital photographs or short videos. In one embodiment, the system 20 may be a mobile or cellular telephone having a digital camera.

Embodiments of the claimed inventions may be used in a “mobile device.” A mobile device, as the phrase is used in this description and the claims, means a computer or communication system, such as a mobile telephone, personal digital assistant, digital music player, digital camera, or other similar device. Embodiments of the claimed inventions may be employed in any device capable of processing image data, including but not limited to computer and communication systems and devices generally.

The term “display device” is used in this description and the claims to refer to any of device capable of rendering images. For example, the term display device may in particular embodiments include hardcopy devices, such as printers and plotters. The term display device additionally refers to all types of display devices, such as CRT, LED, OLED, and plasma devices, without regard to the particular display technology employed.

In this document, references may be made to “one embodiment” or “an embodiment.” These references mean that a particular feature, structure, or characteristic described in connection with the embodiment is included in at least one embodiment of the claimed inventions. Thus, the phrases “in one embodiment” or “an embodiment” in various places are not necessarily all referring to the same embodiment. Furthermore, particular features, structures, or characteristics may be combined in one or more embodiments.

Although embodiments have been described in some detail for purposes of clarity of understanding, it will be apparent that certain changes and modifications may be practiced within the scope of the appended claims. Accordingly, the described embodiments are to be considered as illustrative and not restrictive, and the claimed inventions are not to be limited to the details given herein, but may be modified within the scope and equivalents of the appended claims. Further, the terms and expressions which have been employed in the foregoing specification are used as terms of description and not of limitation, and there is no intention in the use of such terms and expressions to exclude equivalents of the features shown and described or portions thereof, it being recognized that the scope of the inventions are defined and limited only by the claims which follow.

I claim:

1. A method comprising:
inspecting a frame of image data transmitted as a stream of pixels;
selecting at least one of the pixels; and
changing the colors of the selected pixels, wherein the steps of inspecting,
selecting, and changing the colors of the selected pixels are performed as the data is transmitted.

2. The method of claim 1, wherein the frame is transmitted for storing in a memory, further comprising storing the frame in the memory.

3. The method of claim 1, wherein the frame is transmitted from a memory, further comprising fetching the frame from the memory.

4. The method of claim 1, wherein the selected pixels are within a particular region of the frame.

5. The method of claim 1, wherein the selected pixels have a particular color component value.

6. The method of claim 5, wherein the particular color component value is a range of color component values.

7. The method of claim 6, further comprising extracting a minimum and a maximum color component value from a particular region of the frame.

8. A display controller comprising a first unit to receive a frame of pixels from a source, to modify the color of particular received pixels, and to write received pixels to a destination.

9. The display controller of claim 8, wherein the first unit receives, modifies, and writes pixels at at least the rate at which pixels are required by the destination.

10. The display controller of claim 9, wherein the particular received pixels are pixels having a particular color component.

11. The display controller of claim 9, wherein the particular received pixels are pixels located within a particular region of the frame.

12. The display controller of claim 9, wherein the destination is a display device.

13. The display controller of claim 8, wherein the first unit receives, modifies, and writes pixels at at least the rate at which pixels are received from the source.

14. The display controller of claim 13, wherein the particular received pixels are pixels having a particular color component.

15. The display controller of claim 13, wherein the particular received pixels are pixels located within a particular region of the frame.

16. The display controller of claim 13, wherein the source is an image sensor.

17. A system comprising a first unit to receive a frame of pixels from an image data source, to extract the color of first received pixels, to select second received pixels, and to modify the colors of the selected pixels, wherein the color extraction, pixel selection, and color modification are performed as the frame is received.

18. The system of claim 17, wherein the selected pixels are pixels within a first region of the frame.

19. The system of claim 18, wherein the selected pixels additionally are pixels having the extracted color.

20. The system of claim 16, wherein the system is a mobile device.
